(19) United States
(12) Patent Application Publication
(10) Pub. No.: US 2013/0061201 A1
(43) Pub. Date: Mar. 7, 2013

(54) SYSTEM AND METHOD FOR DETERMINING DEFECT TRENDS

(71) Applicant: Amitesh Dayal, Mumbai (IN)

(72) Inventor: Amitesh Dayal, Mumbai (IN)

(73) Assignee: INFOSYS LIMITED, Bangalore (IN)

(21) Appl. No.: 13/342,434

(22) Filed: Jan. 3, 2012

(30) Foreign Application Priority Data
Sep. 5, 2011 (IN) 3049/CHE/2011

(51) Int. Cl. G06F 9/44

(52) U.S. Cl. 717/101

(57) ABSTRACT

The disclosed embodiment relates to a system and method for mapping trends in defects that occur during a project. The method comprised processing defect information related to defects that occurred during a project over a set period of time, the defect information including classification information regarding categories into which the defects are classified, processing at historical defect information and/or historical classification information, wherein the historical defect information includes information related to historical defects that occurred during the project prior to the set period of time and the historical classification information includes information related to categories into which the historical defects are classified, comparing the defect information and/or the classification information with the historical defect information and/or the historical classification information, and determining trends based on the comparison between the defect information and/or the classification information and the historical defect information and/or the historical classification information.

### RELATED APPLICATION DATA

This application claims priority to Indian Patent Application No. 3049/CHE/2011, filed Sep. 5, 2011, which is hereby incorporated by reference in its entirety.

### FIELD OF THE INVENTION

The invention relates to a system and method for determining trends in defects that occur during a project.

### BACKGROUND

Currently, statistical charts can be created (referred to herein as defect reports) based on defects reported for a certain time frame which could be a logical phase of the project, for instance, Unit Testing, System Testing, etc. These charts may include various defect features, such as defects by stage injected, defect severity, defect cause, defect type, and the actual defect data which includes various defect details. If prior defect data needs to be compared to current or more recent defect data, the comparison is done by cursory observation of existing defect reports, and the results of such an observation are weak and inconclusive.

### SUMMARY

The disclosed embodiment relates to a method for mapping trends in defects that occur during a project. The method comprised processing, with a computing device, defect information related to a plurality of defects that occurred during a project over a set period of time, the defect information including classification information regarding one or more categories into which the defects are classified, processing, with a computing device, at least one of historical defect information and historical classification information, wherein the historical defect information includes information related to a plurality of historical defects that occurred during the project prior to the set period of time, and wherein the historical classification information includes information related to one or more categories into which the historical defects are classified, comparing, with a computing device, at least one of the defect information and the classification information with at least one of the historical defect information and the historical classification information, and determining, with a computing device, at least one trend based on the comparison between the at least one of the defect information and the classification information and the at least one of the historical defect information and the historical classification information.

The disclosed embodiment further relates to a system for mapping trends in defects that occur during a project. The system comprises a computing device configured to process defect information related to a plurality of defects that occurred during a project over a set period of time, the defect information including classification information regarding one or more categories into which the defects are classified, a computing device configured to process at least one of historical defect information and historical classification information, wherein the historical defect information includes information related to a plurality of historical defects that occurred during the project prior to the set period of time, and wherein the historical classification information includes information related to one or more categories into which the historical defects are classified, a computing device configured to compare at least one of the defect information and the classification information with at least one of the historical defect information and the historical classification information, and a computing device configured to determine at least one trend based on the comparison between the at least one of the defect information and the classification information and the at least one of the historical defect information and the historical classification information.

The disclosed embodiment also relates to computer-readable code stored on a computer-readable medium that, when executed by a processor, performs a method for mapping trends in defects that occur during a project. The method comprises processing, with a computing device, defect information related to a plurality of defects that occurred during a project over a set period of time, the defect information including classification information regarding one or more categories into which the defects are classified, processing, with a computing device, at least one of historical defect information and historical classification information, wherein the historical defect information includes information related to a plurality of historical defects that occurred during the project prior to the set period of time, and wherein the historical classification information includes information related to one or more categories into which the historical defects are classified, comparing, with a computing device, at least one of the defect information and the classification information with at least one of the historical defect information and the historical classification information, and determining, with a computing device, at least one trend based on the comparison between the at least one of the defect information and the classification information and the at least one of the historical defect information and the historical classification information.

As described herein, the defects may be classified based on the type of defects, the cause of the defects, the severity of the defects, and the stage of the project in which the defects occurred. The trends may relate to changes in the type of defects occurring, changes in the cause of the defects, changes in the rate of occurrence of the defects, changes in the severity of the defects, and changes in the stage of the project in which the defects occurred. Also, the trends may be expressed in terms of the percentage contribution of the defect information or the classification information relative to the historical defect information or the historical classification information. Furthermore, a graphical representation of the trend may be displayed, for example, to a user.

### BRIEF DESCRIPTION OF THE DRAWINGS

FIG. 1 illustrates an overview of an exemplary method according to the disclosed embodiment.

FIG. 2 illustrates a defects summary for a first period of time according to the disclosed embodiment.

FIG. 3 illustrates a defects summary for a second period of time according to the disclosed embodiment.

FIG. 4 illustrates a graphical representation of trends according to the disclosed embodiment.

FIG. 5 illustrates an exemplary computing device useful for implementing systems and performing methods disclosed herein.

### DETAILED DESCRIPTION

The disclosed embodiment relates to the mapping of trends in defect categories or classifications across a period of time, preferably consisting of two or more time periods, across stages of a software development process. This mapping can occur over any period of time, across all software development projects, and across all phases of a project (since defects are entered for all phases). The results of such a mapping have significant value to Respective Analysts, Designers, Coders, Testers, Implementers etc., their respective team leads, project managers, Unit/Division managers, top management, and anyone else associated with the project.

One methods for mapping defects is described as follows. First, deliverables and other documents are scrutinized in the search for defects. Defects detected are entered into a defect database, from which they can be exported into a spreadsheet, such as a Microsoft Excel spreadsheet. These exports may occur at regular time intervals, for example, monthly. Reports based on the defects can be generated using the spreadsheet.

The above described method can be used to create static reports based on data provided at a given time. It does not and cannot compare defect reports with prior or pre-existing reports. To accomplish this, the defects of one time period are required to be manually and superficially compared with the defects of another time period. This is a prohibitively tedious exercise. Thus, trends are simply overlooked. For this reason, it is very difficult to indentify how what aspects of the projects are improving in terms of defects, and where work is needed.

Such a tool can be modified to implement a trending feature. The trending feature should be able to generate trends for defect data spanning ‘n’ time periods (for example, months) or be able to trend across ‘m’ existing defect reports, and should be able to present results by time period, project phase, etc. It should also be able to map defect trends of more than a single project and present data accessible to say, a project manager, a unit manager etc. This capability can also be achieved through the use of an independent tool.

Once the information is presented, causal analysis by a team will help identify possible methods to reduce dominant or concerning defect types. The efficacy of these methods can be measured in the next defect trend report. The best methods then can be shared and reapplied to improve overall software quality.

In contrast to existing methods, the disclosed embodiment facilitates the trending of established defects and defect categories, is not limited to any phase, any level of granularity, or any time period, can be applied to all software development projects, and is preferably used to analyze past data. Solutions are preferably based on team/management discussions.

Benefits of the Defect Trend Mapping

Insights Into Defect Nature: A project team can understand why certain types and causes of defect are persistent and how certain types have shown improvement.

Solution Propagation: If a member or a group in the team has tackled defects in a certain way, the practices and ideas behind the success can be shared with the rest of the team or even with other projects.

Extended Solution Application: The aforementioned practices and ideas can be examined to see if they can be applied to other kinds of defects.

Quality Measure: Project managers, delivery managers and even clients can get a quick summary of the quality and its changes in the project at different levels of granularity—month, phase, project, etc.

Superlative Innovation: By focusing on chronic defects, innovation is ushered into the software development process as team members can focus on persistent problems and new ways to solve them.

Process Benchmarking: Defect trends can serve as a benchmark to test new methodologies and techniques in the software development process, as a whole or in a single phase. Insights into how new practices are mitigating defects can be measured quantitatively.

Enhanced Focus: Current processes for defect reduction, such as code checklists, can be optimized to focus on the most frequent/most severe defects.

Reduction In Project Expenditures: Increased quality and innovation can lead to both short-term and long-team saving in project expenditures and can also benefit other projects in the future.

Organizational Benefits: These benefits achieved, the company itself can grow into a stronger brand with a reputation for rapidly creating high quality software

Proactive Defect Prevention: If the changes in defect severity, causes, types etc. were to be mapped over various reports, the project team can identify positive changes as well as new problems effectively, and progress can be charted over time for enhanced awareness about defects across all stages of a project.

Focused Improvement: These are simply not being brought up in project discussions and are inhibiting profound insights into defects and their prevention. The team can “feel good” about reduction in the contribution of one kind of one defect and “be concerned” about another kind of defect that they though had minimal contribution. Thus, this can also be useful to the project members in identifying where they are improving and where they need to improve.

Quality Measure: This can also be of great use to project managers, delivery managers and even the client wanting to take stock of quality of individual phases of the project or, broadly, the project itself. Higher quality through focused improvement, greater innovation, and cost-saving are the potential benefits of this process.

Every development project encounters defects. By understanding varying defect trends, the development teams can achieve:

Insights into Defect Nature: A project team can understand why certain types and causes of defect are persistent and how they certain types have shown improvement

Solution Propagation: If a member or a group in the team has tackled defects in a certain way, the practices and ideas behind the success can be shared with the rest of the team or even with other projects.

Universal Solution Application: The aforementioned practices and ideas can be examined to see if they can be applied to other kinds of defects

Quality Measure: Project managers, delivery managers and even clients can get a quick summary of the quality and its changes in the project at different levels of granularity—month, phase, project, etc.

Superlative Innovation: By focusing on chronic defects, innovation is ushered into the software development process as team members can focus on persistent problems and new ways to solve them.

Process Benchmarking: Defect trends can serve as a benchmark to test new methodologies and techniques in the software development process, as a whole or in a single phase.

Enhanced Focus: Current processes for defect reduction, such as code checklists, can be optimized to focus on the most frequent/most severe defects.

Reduction in Project Expenditures: Increased quality and innovation can lead to both short-term and long-team saving in project expenditures and can also benefit other projects in the future.

Organizational Benefits: These benefits achieved, the company itself can grow into a stronger brand with a reputation for rapidly creating high quality software

### Overview of the Disclosed Embodiment

Defect analysis tools have historically been limited to certain time periods, and trends in defects are not being analyzed in depth. The disclosed embodiment provides a way to generate intuitive statistics so that changes in defect types, cause, severity, etc. can be analyzed in-depth over a period of time. As described above, the present technology does not have a provision to analyze defects across different time frames. Teams have narrow focus when it comes to defect prevention as they concentrate on the problems at hand. They do not bother with the problems they have already solved and the practices that brought about the solutions. Despite the numerous benefits, especially in terms of quality and innovation, no solution exists for systematically creating hard facts and intuitive statistics to counter defects of all kinds

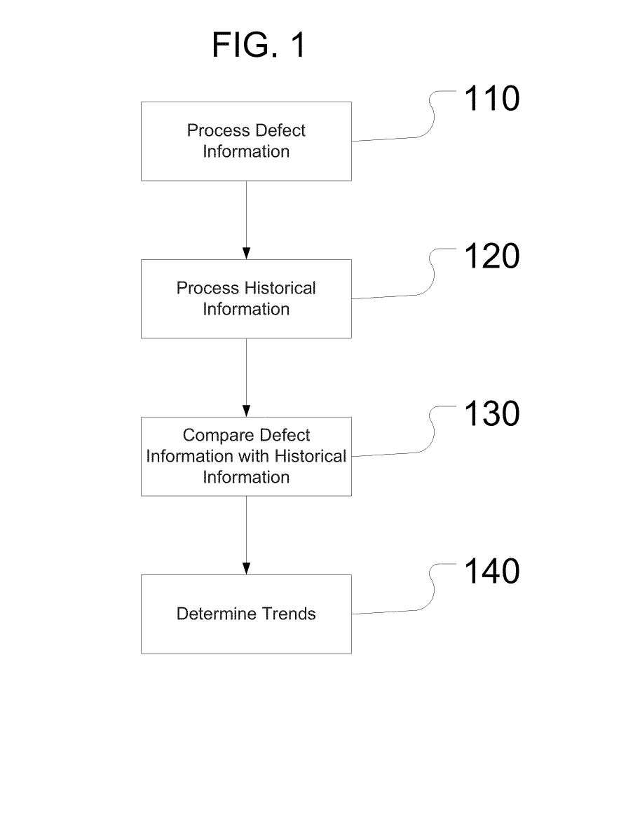

As described herein, and shown in FIG. 1, the disclosed embodiment relates to a method for mapping trends in defects that occur during a project. The method may also be implemented in a system or through the use of computer-readable code.

In step 110, defect information is processed. This information can be received or obtained from any source. The defect information preferably relates to a plurality of defects that occurred during a project over a set period of time. In addition, the defect information preferably includes including classification information regarding one or more categories into which the defects are classified. The defects may be classified based on any characteristics, for example, the type of defects, the cause of the defects, the severity of the defects, the stage of the project in which the defects occurred, and the like.

In step 120, historical information is received or otherwise obtained. This historical information can include historical defect information and/or historical classification information. As described herein, historical defect information preferably includes information related to historical defects that occurred during the project prior to the set period of time, and historical classification information preferably includes information related to categories into which the historical defects are classified.

In step 130, a comparison can be made between the defect information and the historical information. For example, the defect information can be compared to the historical defect information, the classification information can be compared to the historical classification information, or both.

In step 140, trends can be determined based on the comparison in step 130, for example, between the defect information and/or the classification information and the historical defect information and/or the historical classification information. A trend may relate to any of the characteristics of the defect or classification information including, for example, changes in the type of defects occurring, changes in the cause of the defects, changes in the rate of occurrence of the defects, changes in the severity of the defects, changes in the stage of the project in which the defects occurred, and the like. In addition, trends may be expressed in any form, for example, in terms of the percentage contribution of the defect information or the classification information relative to the historical defect information or the historical classification information. Furthermore, a representation of a trend may be presented or displayed to a user or other entity, for example, in graphical form.

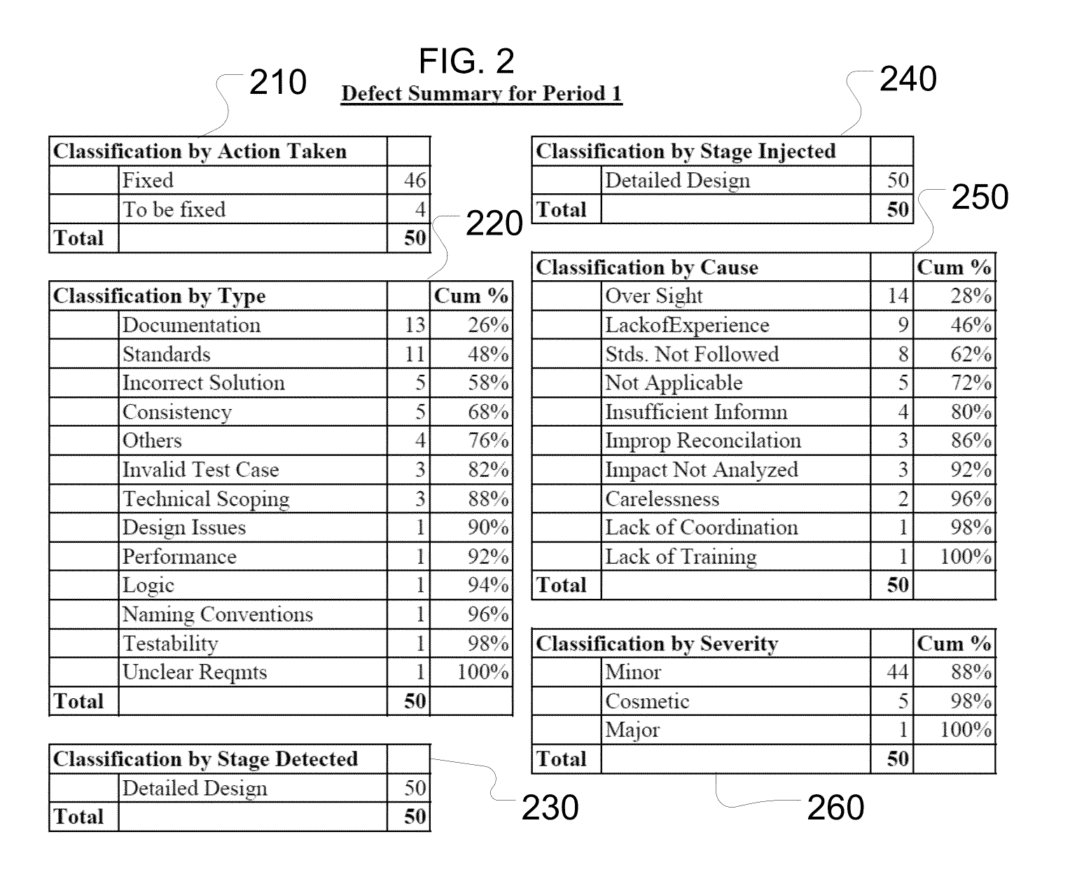

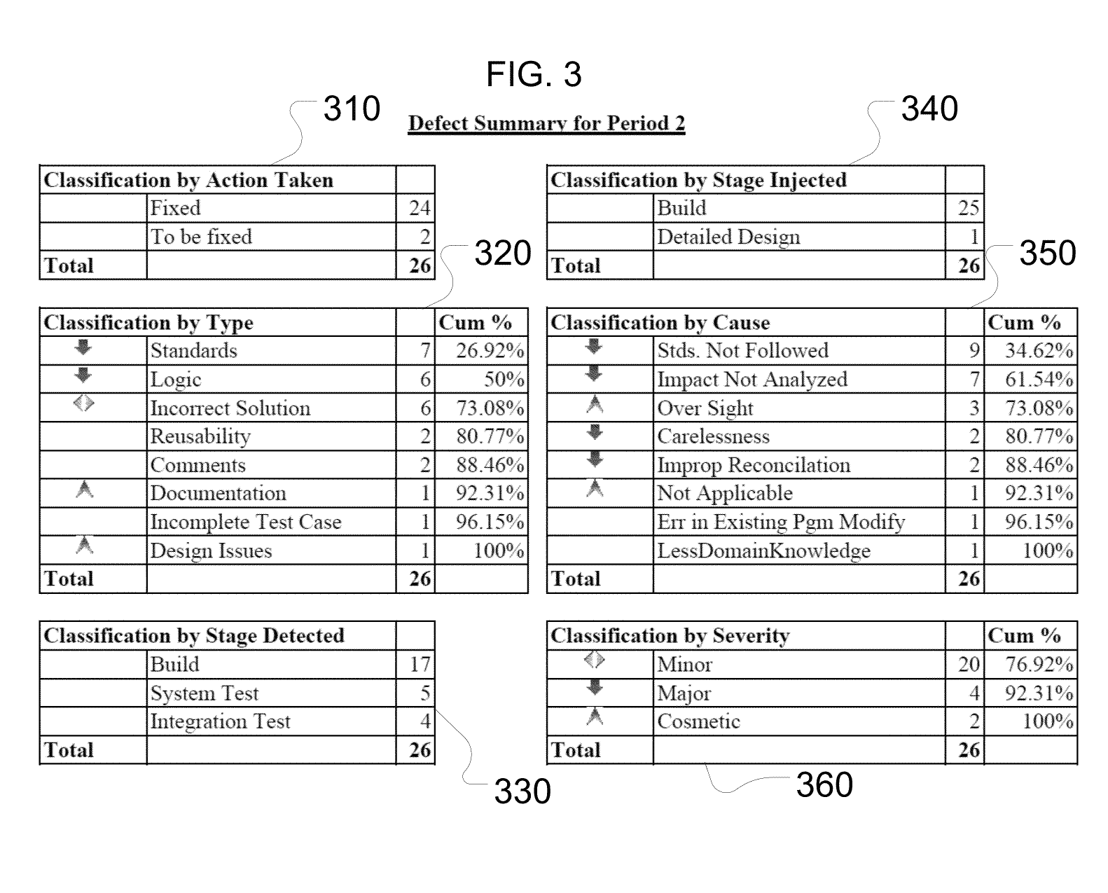

FIGS. 2 and 3 provide an example of a simple defect report and an exemplary report of trending data using various classifications. FIG. 2 is a defects summary for a first period of time in which 50 defects were detected and reported. This data is an example of historical data, as explained herein. As shown in FIG. 2, defects are classified by classifications includes Action Taken 210, Type 220, Stage Detected 230, Stage Injected 240, Cause 250, and Severity 260, although any classification system may be used. For each classification, the number of defects are reported, and the cumulative percentages are presented, if applicable.

FIG. 3 is a defects summary for a second period of time in which 26 defects were detected and reported. As with FIG. 2, defects are classified by classifications includes Action Taken 310, Type 320, Stage Detected 330, Stage Injected 340, Cause 350, and Severity 360, although any classification system may be used. For each classification, as in FIG. 2, the number of defects are reported, and the cumulative percentages are presented, if applicable.

However, in addition, trending data has been added to FIG. 3. The trending data represents the standing of each defect by severity, cause, and type as compared to the previous report in FIG. 2. The arrows indicate the changes in the percentage contribution of a certain kind of defect, for example. Any suitable indicator may be used. By using indicators, such as arrows, change in absolute rank of defects across categories can be highlighted and emphasized. Other symbols can be used for new causes introduced as well as causes successfully eliminated as compared to the previous report.

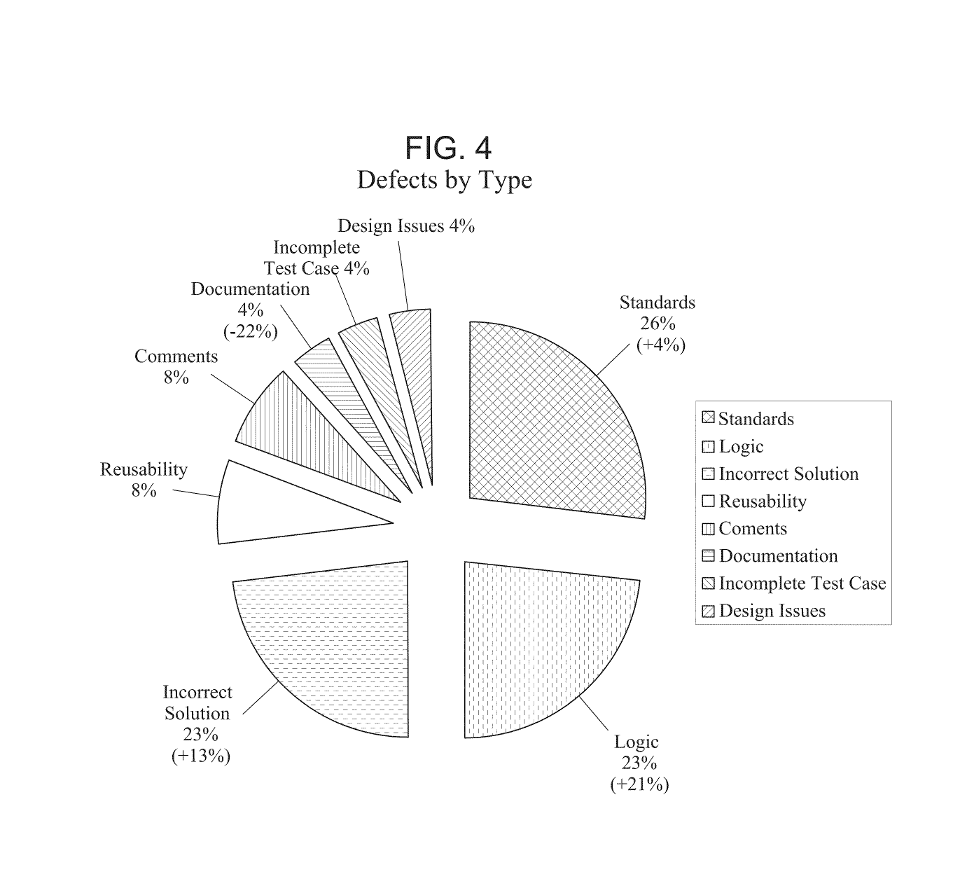

After the trends are determined, the results can be displayed in a meaningful way, for example, graphically. FIG. 4 is a chart that shows the trend changes between FIG. 2 and FIG. 3 in the Type category. Using FIG. 4, it is easily determined that the defects of the type “Standard,” for example, represented 26% of the total defects in period 2 (FIG. 3), which was a percentage increase of 4% from the 22% in period 1 (FIG. 2). Similarly, the defects of the type “Documentation,” for example, represented only 4% of the total defects in period 2 (FIG. 3, which was a percentage decrease of 22% from the 26% in period 1 (FIG. 2). Thus, using this information, it can easily be determined which areas have seen, or may need, improvements. Any of the determined trends can be represented graphically in similar fashion.

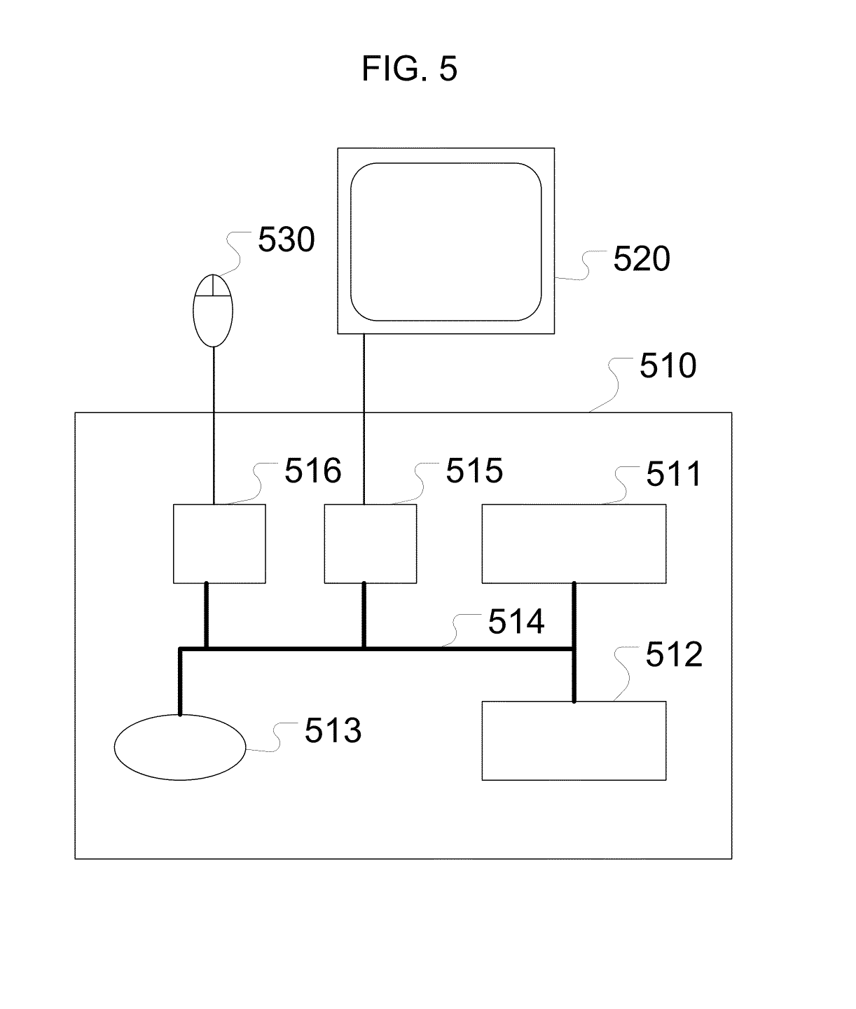

These embodiments may be implemented with any suitable hardware and/or software configuration, including, for example, modules executed on computing devices such as computing device 510 of FIG. 5. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 510 has one or more processing device 511 designed to process instructions, for example computer readable instructions (i.e., code) stored on a storage device 513. By processing instructions, processing device 511 may perform the steps set forth in the methods described herein. Storage device 513 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 510 additionally has memory 512, an input controller 516, and an output controller 515. A bus 514 operatively couples components of computing device 510, including processor 511, memory 512, storage device 513, input controller 516, output controller 515, and any other devices (e.g., network controllers, sound controllers, etc.). Output controller 515 may be operatively coupled (e.g., via a wired or wireless connection) to a display device 520 (e.g., a monitor, television, mobile device screen, touch-display, etc.) in such a fashion that output controller 515 can transform the display on display device 520 (e.g., in response to modules executed). Input controller 516 may be operatively coupled (e.g., via a wired or wireless connection) to input device 550 (e.g., mouse, keyboard, touch-pad, scroll-ball, touch-display, etc.) in such a fashion that input can be received from a user (e.g., a user may input with an input device 550 a dig ticket).

Of course, FIG. 5 illustrates computing device 510, display device 520, and input device 550 as separate devices for ease of identification only. Computing device 510, display device 520, and input device 550 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 510 may be one or more servers, for example a farm of networked servers, a clustered server environment, or a cloud network of computing devices.

While systems and methods are described herein by way of example and embodiments, those skilled in the art recognize that the systems and methods for determining defect trends are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A method for mapping trends in defects that occur during a project, the method comprising:
processing, with a computing device, defect information related to a plurality of defects that occurred during a project over a set period of time, the defect information including classification information regarding one or more categories into which the defects are classified;
processing, with a computing device, at least one of historical defect information and historical classification information, wherein the historical defect information includes information related to a plurality of historical defects that occurred during the project prior to the set period of time, and wherein the historical classification information includes information related to one or more categories into which the historical defects are classified;
comparing, with a computing device, at least one of the defect information and the classification information with at least one of the historical defect information and the historical classification information; and
determining, with a computing device, at least one trend based on the comparison between the at least one of the defect information and the classification information and the at least one of the historical defect information and the historical classification information.

2. The method of claim 1, wherein the defects are classified based on at least of the type of defects, the cause of the defects, the severity of the defects, and the stage of the project in which the defects occurred.

3. The method of claim 1, wherein the at least one trend relates to at least one of changes in the type of defects occurring, changes in the cause of the defects, changes in the rate of occurrence of the defects, changes in the severity of the defects, and changes in the stage of the project in which the defects occurred.

4. The method of claim 3, wherein the at least one trend is expressed in terms of the percentage contribution of the defect information or the classification information relative to the historical defect information or the historical classification information.

5. The method of claim 1, further comprising displaying, by a computing device, a graphical representation of the at least one trend.

6. A system for mapping trends in defects that occur during a project, the system comprising:
a computing device configured to process defect information related to a plurality of defects that occurred during a project over a set period of time, the defect information including classification information regarding one or more categories into which the defects are classified;
a computing device configured to process at least one of historical defect information and historical classification information, wherein the historical defect information includes information related to a plurality of historical defects that occurred during the project prior to the set period of time, and wherein the historical classification information includes information related to one or more categories into which the historical defects are classified;
a computing device configured to compare at least one of the defect information and the classification information with at least one of the historical defect information and the historical classification information; and
a computing device configured to determine at least one trend based on the comparison between the at least one of the defect information and the classification information and the at least one of the historical defect information and the historical classification information.

7. The system of claim 6, wherein the defects are classified based on at least of the type of defects, the cause of the defects, the severity of the defects, and the stage of the project in which the defects occurred.

8. The system of claim 6, wherein the at least one trend relates to at least one of changes in the type of defects occurring, changes in the cause of the defects, changes in the rate of occurrence of the defects, changes in the severity of the defects, and changes in the stage of the project in which the defects occurred.

9. The system of claim 8, wherein the at least one trend is expressed in terms of the percentage contribution of the defect information or the classification information relative to the historical defect information or the historical classification information.

10. The system of claim 6, further comprising a computing device configured to display a graphical representation of the at least one trend.

11. Computer-readable code stored on a computer-readable medium that, when executed by a processor, performs a method for mapping trends in defects that occur during a project, the method comprising:
processing, with a computing device, defect information related to a plurality of defects that occurred during a project over a set period of time, the defect information including classification information regarding one or more categories into which the defects are classified;
processing, with a computing device, at least one of historical defect information and historical classification information, wherein the historical defect information includes information related to a plurality of historical defects that occurred during the project prior to the set period of time, and wherein the historical classification information includes information related to one or more categories into which the historical defects are classified;
comparing, with a computing device, at least one of the defect information and the classification information with at least one of the historical defect information and the historical classification information; and
determining, with a computing device, at least one trend based on the comparison between the at least one of the defect information and the classification information and the at least one of the historical defect information and the historical classification information.

12. The computer-readable code of claim 11, wherein the defects are classified based on at least of the type of defects, the cause of the defects, the severity of the defects, and the stage of the project in which the defects occurred.

13. The computer-readable code of claim 11, wherein the at least one trend relates to at least one of changes in the type of defects occurring, changes in the cause of the defects, changes in the rate of occurrence of the defects, changes in the severity of the defects, and changes in the stage of the project in which the defects occurred.

14. The computer-readable code of claim 13, wherein the at least one trend is expressed in terms of the percentage contribution of the defect information or the classification information relative to the historical defect information or the historical classification information.

15. The computer-readable code of claim 11, wherein the method further comprises displaying, by a computing device, a graphical representation of the at least one trend.
